(19) United States
(12) Patent Application Publication
(10) Pub. No.: US 2002/0014059 A1
(43) Pub. Date: Feb. 7, 2002

(54) Implement for treating a soil surface

(75) Inventors: Alexander van der Lely, Rotterdam (NL); Maarten Koorn, Schiedam (NL); Cornelis Franciscus Johannes Geerts, Moergestel (NL)

Correspondence Address: Penrose Lucas Albright, Esq., MASON, MASON & ALBRIGHT, P.O. Box 2246, Arlington, VA, 22202-0246, US

(73) Assignee: LELY ENTERPRISES AG, a Swiss Limited Liability co.

(21) Appl. No.: 09/911,576

(22) Filed: Jul. 25, 2001

(30) Foreign Application Priority Data
Jul. 25, 2000 (NL) 1015801

(51) Int. Cl. A01D 75/00

(52) U.S. Cl. 56/10.2 E; 56/10.2 F

(57) ABSTRACT

The invention relates to an implement for treating a soil surface, such as for example raking together grass and/or hay, said implement (1) being provided with a frame (2) comprising at least one, preferably motor-drivable, treating unit (3) provided with treating elements for treating the soil surface. The implement (1) is provided with measuring means (13) which are suitable for feeling and/or scanning the soil surface to be treated and for determining ground irregularities, such as slopes and/or holes for example, that may be present in the soil surface, as well as with adjusting means (11) that adjust automatically the orientation and/or height of at least one treating element relative to the soil surface, on the basis of the measuring results of the measuring means (13).

The invention relates to an implement for treating a soil surface, such as for example raking together grass and/or hay, said implement being provided with a frame comprising at least one, preferably motor-drivable, treating unit provided with treating elements for treating the soil surface.

Such an implement is known.

It is an object of the invention to improve such an implement. In accordance with the invention this is achieved in that the implement is provided with measuring means which are suitable for feeling and/or scanning the soil surface to be treated and for determining ground irregularities, such as slopes and/or holes for example, that may be present in the soil surface, as well as with adjusting means that adjust automatically the orientation and/or height of at least one treating element relative to the soil surface, on the basis of the measuring results of the measuring means. In the situation that the treating unit is designed as a rake for example, it is thus possible to realize good raking results, even in case of an uneven soil surface, due to the fact that the rake tines of the rake are individually adjusted in height relative to the ground. It will be obvious that, when the treating unit is constituted by an other agricultural implement, such as a mowing machine for example, this agricultural machine has similar advantages.

Instead of comprising measuring means, the implement may be provided, according to a further embodiment of the invention, with a storage medium which is suitable for storing data regarding the soil surface, in particular the irregularities in the soil surface to be treated, as well as with means for determining the position, such as DGPS for example, with the aid of which the current position of at least one treating element is determined, and with adjusting means that adjust automatically the orientation and/or height of the relevant treating element relative to the soil surface, on the basis of the current position of the relevant treating element and the stored data regarding the soil surface at that place. Therefore, the invention also relates to an implement for treating a soil surface, such as raking together grass and/or hay for example, said implement being provided with a frame comprising at least one, preferably motor-drivable, treating unit provided with treating elements for treating a soil surface, characterized in that the implement is provided with a storage medium which is suitable for storing data regarding the soil surface, in particular the irregularities in the soil surface to be treated, as well as with means for determining the position, such as DGPS for example, with the aid of which the current position of at least one treating element is determined, and with adjusting means that adjust automatically the orientation and/or height of the relevant treating element relative to the soil surface, on the basis of the current position of the relevant treating element and the stored data regarding the soil surface at that place. It will be obvious that it is also possible to combine the two implements according to the invention, so that the treating elements are adjusted on the basis of measurements carried out with the aid of the measuring means and on the basis of the data regarding the soil surface stored in the storage medium. It is further possible, if desired, to adjust data regarding the soil surface stored in the storage medium with the aid of data regarding the soil surface at that place obtained by the measuring means.

According to a further inventive feature, the measuring means comprise one or more sensors which, seen in the direction of travel of the implement, feel and/or scan the soil surface in front of the relevant treating element. According to again another inventive feature, the sensors are disposed on the frame. In a preferred embodiment of the invention, the sensors are designed as ultrasonic sensors. According to again another inventive feature, the sensors may comprise a camera. However, it will be obvious that also many other sensors than the sensors mentioned above may be applied. According to again another inventive feature, the adjusting means comprise at least one control element which is suitable for adjusting a relevant treating element in height, seen in the direction of travel of the implement. According to an inventive feature, the control element controls a hingeable construction constituting part of the adjusting means. According to a further inventive feature, the hingeable construction comprises an arm with a horizontal hinge pin. In a further embodiment of the invention the control element comprises a second hingeable construction constituting patt of the adjusting means. According to a further inventive feature, the arm of the hingeable construction comprises a second horizontal hinge pin. In a preferred embodiment of the invention the hingeable construction comprises a quadrangular pivot construction. According to a further inventive feature, the quadrangular pivot construction is designed as a parallelogram. According to another inventive feature, it is further possible to adjust the treating unit in height relative to the soil surface. In the situation that three control elements are applied, it is possible to adjust the treating unit omnidirectionally relative to the soil surface. In a preferred embodiment of the invention the control elements are designed as control cylinders or stepper motors. For the purpose of realizing the above-mentioned tilting movement in a simple manner, according to the invention the adjusting means comprise one or more ball joints. According to again another aspect of the invention, the adjusting means comprise a clinometer which is suitable for determining the angle that is enclosed by a relevant treating element and/or a relevant treating unit and the soil surface. According to again another aspect of the invention, the adjusting means comprise height measuring means which are suitable for determining the height assumed by a relevant treating element and/or a relevant treating unit relative to the soil surface. According to another further inventive feature, the treating unit is designed as a motor-drivable rake or tedder. According to a further inventive feature, the rake comprises tine arms which are pivoted through a curve path. According to another inventive feature, the implement comprises a driving speed sensor. According to another further inventive feature, the implement comprises an rpm-sensor which is suitable for determining the number of revolutions of the treating unit and/or the treating element. With the aid of the driving speed sensor and the rpm-sensor it is possible, depending on the conditions of the surface to be treated, optimally to adjust the working depth of the treating unit and/or the treating element. With a rake or a tedder for example, at an unchanging number of revolutions of the treating unit and at an increased driving speed, it is possible to choose a deeper adjustment of the treating unit and/or the treating element.

The invention will now be explained in further detail with reference to the accompanying figures, in which

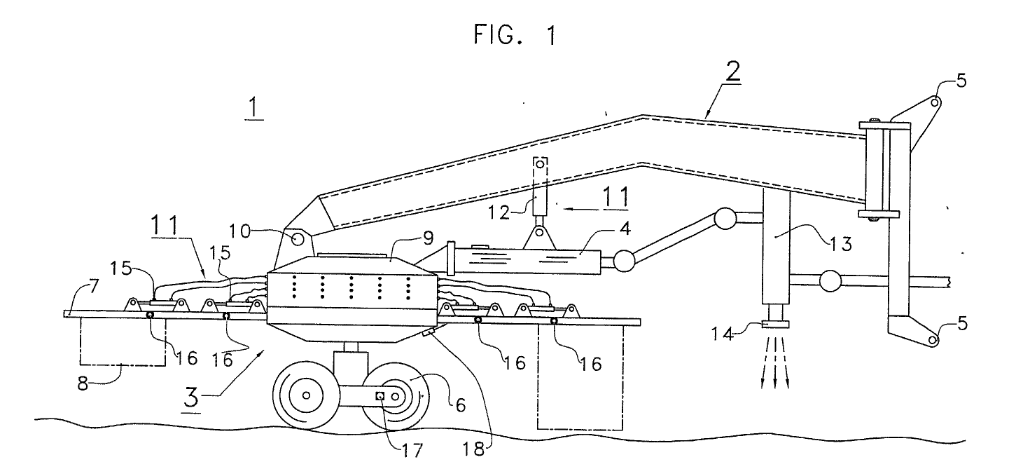

FIG. 1 is a side view of a first embodiment of an implement according to the invention;

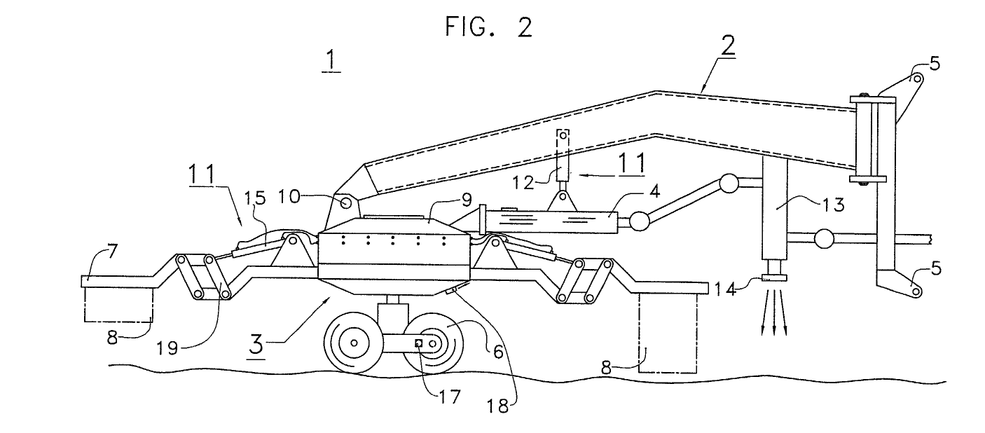

FIG. 2 is a side view of a second embodiment of the implement according to the invention, and

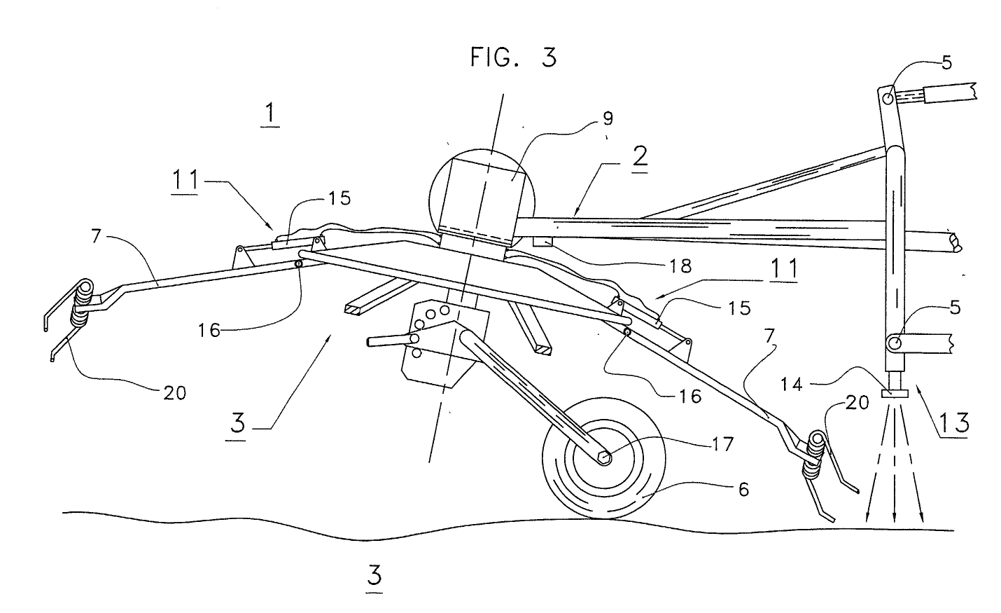

FIG. 3 is a side view of a third embodiment of the implement according to the invention.

FIG. 1 is a side view of a first embodiment of an implement 1 according to the invention, said implement being provided with a frame 2 comprising a treating unit 3 which is designed as a rake in the present embodiment. The rake 3 is motor-drivable via a transmission 4. The frame 2 is further provided with coupling means 5 with the aid of which the implement can be coupled to a vehicle, such as a tractor for example. In the present embodiment the rake 3 is supported by a wheel set 6 that is designed as a tandem wheel set. The rake 3 is further provided with a plurality of treating elements comprising all tine arms 7 having at their ends rake tines 8. The tine arms 7 are controlled via a central box 9 with a curve path therein. The central box 9 is connected with the frame 2 via a horizontal hinge pin 10. Between the frame 2 and the transmission 4 there are further provided first adjusting means 11 with the aid of which the treating unit 3 can be adjusted relative to the soil surface by pivoting about the horizontal hinge pin 10. In the present embodiment the adjusting means 11 comprise a control cylinder 12 which is preferably designed as a servo-pneumatic control cylinder. The implement 1 is further provided with measuring means 13 which are suitable for feeling and/or scanning the soil surface to be treated and determining ground irregularities, such as slopes and/or holes for example, that may be present therein. The measuring means 13 comprise a plurality of sensors 14 which are disposed near the front side of the frame 2 and which are capable of feeling and/or scanning the soil at least over the full working width of the implement 1. The treating elements are also provided with adjusting means 11 which are suitable for adjusting a relevant treating element in height relative to the soil. The adjusting means 11 comprise two control elements 15 which are provided on each of the tine arms 7. In the present embodiment the control elements 15 are designed as a control cylinder which is capable of pivoting part of the tines about a horizontal axis 16. Each of the tine arms 7 comprising two hingeable constructions that are controllable by the control cylinders, it is possible to displace the rake tines 8 more or less parallel in height relative to the soil. However, it will be obvious that it is also possible to equip a tine arm 7 with one hingeable construction with the aid of which the rake tine is adjusted in height. In the latter situation, however, it is not possible to adjust the rake tines as optimally as in the situation of two hingeable constructions. The implement is further provided with a driving speed sensor 17 which is disposed near the wheel set 6 and which is suitable for determining the driving speed of the implement 1. On the central box 9 there is further provided an rpm-sensor 18 which is suitable for determining the number of revolutions of the tine arms 7. When there is measured by the measuring means 13 a difference in height in the soil, the rake tines 8 of the rake 3 are adjusted with the aid of the adjusting means 11 in such a manner that the distance from the rake tines to the soil is maintained. In this way the rake tines are prevented from moving through the soil or extending far above the soil, so that they cannot take along grass or hay.

FIG. 2 shows a second embodiment of an implement according to the invention, in which parts corresponding to those in the first embodiment are indicated by the same reference numerals. In the second embodiment of the invention the hingeable construction comprises a quadrangular pivot construction 19 which is designed as a parallelogram construction in the present embodiment. Such an embodiment has the advantage that the ends of the rake tines can be adjusted in height parallel to the ground by means of one control cylinder.

FIG. 3 shows a third embodiment of an implement according to the invention, in which parts corresponding to those in the first and second embodiment are indicated by the same reference numerals. In the third embodiment the implement 1 is designed as a tedder with tedder members 3. At the end of the tine arms 7 there are provided tedder tines 20. In general, with a tedder one hingeable construction per tine arm 7 suffices, because the orientation of the tedder tine 20 hardly changes, the working width of a tedder tine being smaller than that of a rake tine.

1. An implement for treating a soil surface, such as for example raking together grass and/or hay, said implement (1) being provided with a frame (2) comprising at least one, preferably motor-drivable, treating unit (3) provided with treating elements for treating the soil surface, characterized in that the implement (1) is provided with measuring means (13) which are suitable for feeling and/or scanning the soil surface to be treated and for determining ground irregularities, such as slopes and/or holes for example, that may be present in the soil surface, as well as with adjusting means (11) that adjust automatically the orientation and/or height of at least one treating element relative to the soil surface, on the basis of the measuring results of the measuring means (13).

2. An implement for treating a soil surface, such as for example raking together grass and/or hay, said implement (1) being provided with a frame (2) comprising at least one, preferably motor-drivable, treating unit (3) provided with treating elements for treating the soil surface, characterized in that the implement (1) is provided with a storage medium which is suitable for storing data regarding the soil surface, in particular the irregularities in the soil surface to be treated, as well as with means for determining the position, such as DGPS for example, for determining the current position of at least one treating element, and with adjusting means (11) that are suitable for automatically adjusting the orientation and/or height of the relevant treating element relative to the soil surface, on the basis of the current position of the relevant treating element and the stored data regarding the soil surface at that place.

3. An implement as claimed in claim 2, characterized in that the implement (1) is provided with measuring means (13) which are suitable for feeling and/or scanning the soil surface to be treated and for determining ground irregularities, such as slopes and/or holes for example, that may be present therein.

4. An implement as claimed in claim 1 or 3, characterized in that the measuring means (13) comprise one or more sensors (14) which, seen in the direction of travel of the implement (1), feel and/or scan the soil surface in front of the relevant treating element.

5. An implement as claimed in claim 4, characterized in that the sensors (14) are disposed on the frame (2).

6. An implement as claimed in claim 5, characterized in that the sensors (14) are designed as ultrasonic sensors.

7. An implement as claimed in claim 5, characterized in that the sensors (14) comprise a camera.

8. An implement as claimed in any one of the preceding claims, characterized in that the adjusting means (11) comprise at least one control element (15) which is suitable for adjusting in height the relevant treating element.

9. An implement as claimed in claim 8, characterized in that the control element (15) controls a hingeable construction constituting part of the adjusting means (11).

10. An implement as claimed in claim 9, characterized in that the hingeable construction comprises an arm with a horizontal hinge pin (16).

11. An implement as claimed in claim 9 or 10, characterized in that the control element (15) comprises a second hingeable construction constituting part of the adjusting means (11).

12. An implement as claimed in claim 11, characterized in that the arm of the hingeable construction comprises a second horizontal hinge pin (16).

13. An implement as claimed in any one of claims 8 to 12, characterized in that the hingeable construction comprises a quadrangular pivot constriction (19).

14. An implement as claimed in claim 13, characterized in that the quadrangular pivot construction (19) is designed as a parallelogram.

15. An implement as claimed in any one of claims 8 to 14, characterized in that the control elements (12, 15) are designed as control cylinders or stepper motors.

16. An implement as claimed in any one of the preceding claims, characterized in that the treating unit (3) is adjustable in height relative to the soil surface.

17. An implement as claimed in claim 16, characterized in that the treating unit (3) is omnidirectionally adjustable relative to the height.

18. An implement as claimed in any one of the preceding claims, characterized in that the adjusting means (11) comprise a ball joint.

19. An implement as claimed in any one of the preceding claims, characterized in that the adjusting means (11) comprise a clinometer which is suitable for determining the angle enclosed by a relevant treating element and/or a relevant treating unit (3) and the soil surface.

20. An implement as claimed in any one of the preceding claims, characterized in that the adjusting means (11) comprise height measuring means which are suitable for determining the height assumed by the treating element and/or the treating unit (3) relative to the soil surface.

21. An implement as claimed in any one of the preceding claims, characterized in that the treating unit (3) is designed as a motor-drivable tedder.

22. An implement as claimed in any one of the preceding claims, characterized in that the treating unit (3) is designed as a motor-drivable rake (3).

23. An implement as claimed in claim 22, characterized in that the rake comprises tine arms (7) which are pivoted through a curve path.

24. An implement as claimed in any one of the preceding claims, characterized in that the implement comprises a driving speed sensor (17).

25. An implement as claimed in any one of the preceding claims, characterized in that the implement comprises an rpm-sensor (18) which is suitable for determining the number of revolutions of the treating unit (3) and/or the treating element.
